(19) United States
(12) Patent Application Publication
(10) Pub. No.: US 2019/0193912 A1
(43) Pub. Date: Jun. 27, 2019

(54) Vacuum Bag Assembly

(71) Applicant: Ronald McLeod, Golden, CO (US)

(72) Inventor: Ronald McLeod, Golden, CO (US)

(21) Appl. No.: 15/851,137

(22) Filed: Dec. 21, 2017

(51) Int. Cl. B65D 81/20; B65F 1/00; B65B 31/04

(52) U.S. Cl. CPC B65D 81/2038; B65F 1/002; B65F 2240/138; B65D 81/2023; B65B 31/048; B65B 31/047

(57) ABSTRACT

A vacuum bag assembly includes a bag that may contain yard waste. A valve is coupled to the bag such that the valve is in fluid communication with an interior of the bag. The valve is selectively coupled to a vacuum thereby facilitating air to be drawn out of the bag such that the bag is collapsed to a minimum size. A closure is coupled to the bag and the closure is selectively manipulated. The closure selectively closes the bag to retain the yard waste in the bag. Moreover, the closure forms a fluid impermeable seal to inhibit air from entering and escaping the bag.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to bag devices and more particularly pertains to a new bag device for containing yard waste.

### BRIEF SUMMARY OF THE INVENTION

An embodiment of the disclosure meets the needs presented above by generally comprising a bag that may contain yard waste. A valve is coupled to the bag such that the valve is in fluid communication with an interior of the bag. The valve is selectively coupled to a vacuum thereby facilitating air to be drawn out of the bag such that the bag is collapsed to a minimum size. A closure is coupled to the bag and the closure is selectively manipulated. The closure selectively closes the bag to retain the yard waste in the bag. Moreover, the closure forms a fluid impermeable seal to inhibit air from entering and escaping the bag.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a vacuum bag assembly according to an embodiment of the disclosure.

FIG. 2 is a bottom phantom view of an embodiment of the disclosure.

FIG. 3 is a perspective in-use view of an embodiment of the disclosure.

FIG. 4 is a cross sectional view taken along line 4-4 of FIG. 3 of an embodiment of the disclosure.

### DETAILED DESCRIPTION OF THE INVENTION

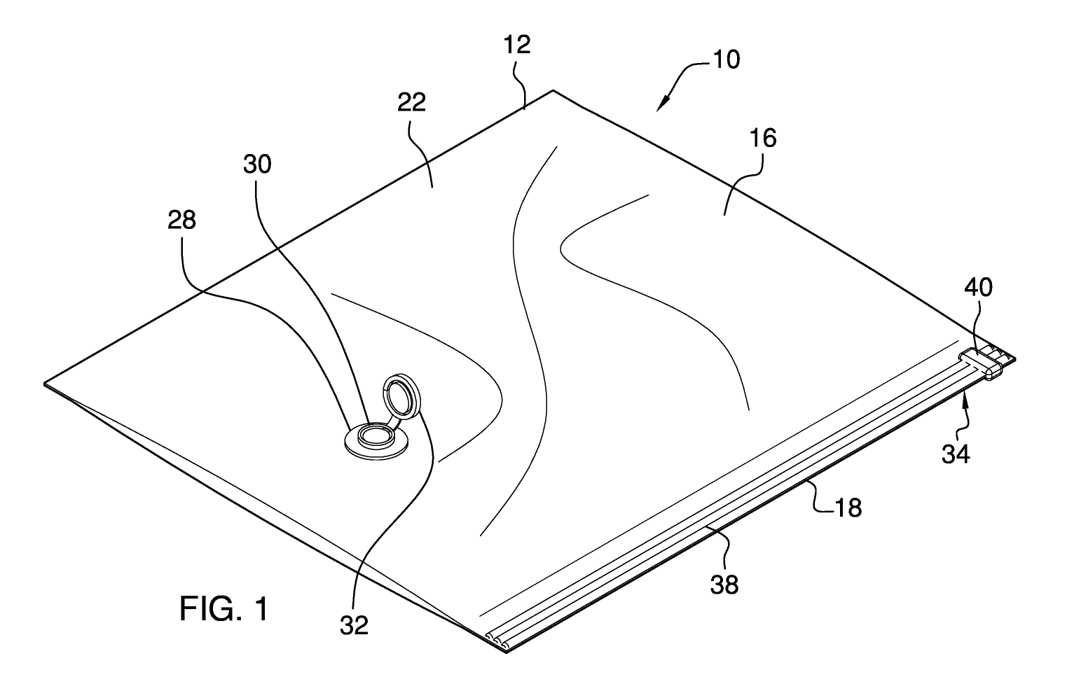

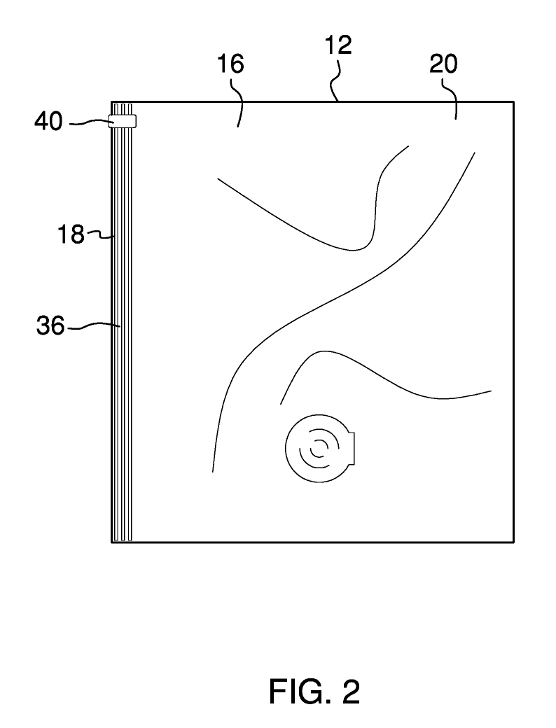

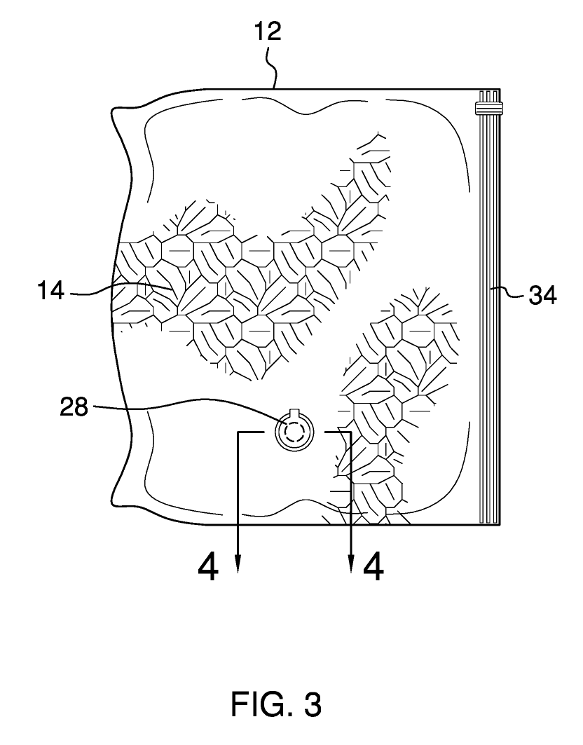

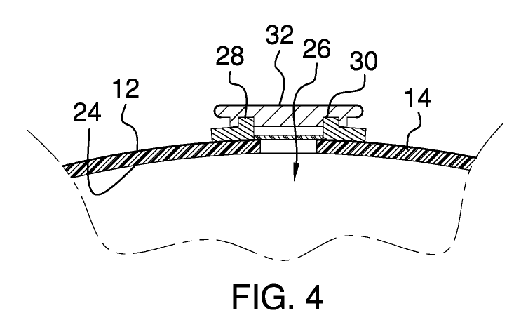

With reference now to the drawings, and in particular to FIGS. 1 through 4 thereof, a new bag device embodying the principles and concepts of an embodiment of the disclosure and generally designated by the reference numeral 10 will be described.

As best illustrated in FIGS. 1 through 4, the vacuum bag assembly 10 generally comprises a bag 12 that may contain yard waste 14. The bag 12 has an outer wall 16 and a top edge 18, and the top edge 18 is open to access an interior of the bag 12. The outer wall 16 has a first side 20, a second side 22 and an inside surface 24. Moreover, the outer wall 16 has an aperture 26 extending into an interior of the bag 12. The bag 12 is comprised of a fluid impermeable material such as poly vinyl chloride or the like

A valve 28 is coupled to the bag 12 such that the valve 28 is in fluid communication with an interior of the bag 12. The valve 28 is selectively coupled to a vacuum, such as an electric vacuum or the like, thereby facilitating air to be drawn out of the bag 12. In this way the bag 12 is collapsed to a minimum size. Thus, the bag 12 and the yard waste within the bag 12 occupy a minimum amount of space.

The valve 28 is positioned in the aperture 26 and the valve 28 has a first end 30. The first end 30 is open and the first end 30 is exposed with respect to the bag 12. The first end 30 is selectively coupled to the vacuum. The valve 28 includes a cap 32 and the cap 32 is selectively positioned on the first end 30 to close the first end 30. Moreover, the cap 32 forms a fluid impermeable seal with the first end 30. Additionally, the valve 28 may be a one way air valve of any conventional design such that the valve 28 inhibits air from entering the bag 12 when the air is vacuumed from the bag 12.

A closure 34 is coupled to the bag 12 and the closure 34 is selectively manipulated. The closure 34 selectively closes the bag 12 to retain the yard waste in the bag 12. Moreover, the closure 34 forms a fluid impermeable seal to inhibit air from entering and escaping the bag 12. The closure 34 comprises a first mating member 36 that is coupled to the inside surface 24 corresponding to the first side 20 of the bag 12. The first mating member 36 is coextensive with the top edge 18.

A second mating member 38 is provided and the second mating member 38 is coupled to the inside surface 24 corresponding to the second side 22 of the bag 12. The second mating member 38 is coextensive with the top edge 18. Moreover, the second mating member 38 selectively engages the first mating member 36 to selectively close the bag 12. The second mating member 38 forms a fluid impermeable seal with the first member. Each of the first 36 and second 38 mating members may comprise a zipper or the like.

A slide 40 is slidably coupled to the bag 12 and the slide 40 is selectively manipulated. The slide 40 is positioned on the top edge 18 and the slide 40 is in mechanical communication with each of the first 36 and second 38 mating members. Moreover, the slide 40 selectively opens and closes the bag 12. The slide 40 separates the first mating member 36 from the second mating member 38 when the slide 40 is urged in a first position. The slide 40 engages the first mating member 36 to the second mating member 38 when the slide 40 is urged in a second position.

In use, the bag 12 is filled with the yard waste 14 and the slide 40 is urged in the second position to close the bag 12. The valve 28 is fluidly coupled to the vacuum and the air is removed from the bag 12. In this way the bag 12 and the yard waste 14 are collapsed to the minimum size. Thus, the bag 12 and the yard waste 14 occupy a minimum amount of space when the bag 12 and yard waste are positioned on a curb for pickup. The slide 40 is selectively urged in the first position to open the bag 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vacuum bag assembly being configured to contain yard waste, said assembly comprising:
a bag being configured to contain yard waste;
a valve being coupled to said bag such that said valve is in fluid communication with an interior of said bag, said valve being configured to be selectively coupled to a vacuum thereby facilitating air to be drawn out of said bag such that said bag is collapsed to a minimum size; and
a closure being coupled to said bag wherein said closure is configured to be manipulated, said closure selectively closing said bag wherein said closure is configured to retain the yard waste in said bag, said closure forming a fluid impermeable seal wherein said closure is configured to inhibit air from entering and escaping said bag.

2. The assembly according to claim 1, wherein said bag has an outer wall and a top edge, said top edge being open to access an interior of said bag, said outer wall having a first side, a second side and an inside surface, said outer wall having an aperture extending into an interior of said bag.

3. The assembly according to claim 2, wherein said valve is positioned in said aperture, said valve having a first end, said first end being open, said first end being exposed with respect to said bag, said first end being configured to be selectively coupled to the vacuum, said valve including a cap, said cap being selectively positioned on said first end to close said first end, said cap forming a fluid impermeable seal with said first end.

4. The assembly according to claim 2, wherein said closure comprises a first mating member being coupled to said inside surface corresponding to said first side of said bag, said first mating member being coextensive with said top edge.

5. The assembly according to claim 4, further comprising a second mating member being coupled to said inside surface corresponding to said second side of said bag, said second mating member being coextensive with said top edge, said second mating member selectively engaging said first mating member to selectively close said bag, said second mating member forming a fluid impermeable seal with said first member.

6. The assembly according to claim 5, further comprising a slide being slidably coupled to said bag wherein said slide is configured to be manipulated, said slide being positioned on said top edge, said slide being in mechanical communication with each of said first and second mating members, said slide selectively opening and closing said bag.

7. A vacuum bag assembly being configured to contain yard waste, said assembly comprising:
a bag being configured to contain yard waste, said bag having an outer wall and a top edge, said top edge being open to access an interior of said bag, said outer wall having a first side, a second side and an inside surface, said outer wall having an aperture extending into an interior of said bag;
a valve being coupled to said bag such that said valve is in fluid communication with an interior of said bag, said valve being configured to be selectively coupled to a vacuum thereby facilitating air to be drawn out of said bag such that said bag is collapsed to a minimum size, said valve being positioned in said aperture, said valve having a first end, said first end being open, said first end being exposed with respect to said bag, said first end being configured to be selectively coupled to the vacuum, said valve including a cap, said cap being selectively positioned on said first end to close said first end, said cap forming a fluid impermeable seal with said first end; and
a closure being coupled to said bag wherein said closure is configured to be manipulated, said closure selectively closing said bag wherein said closure is configured to retain the yard waste in said bag, said closure forming a fluid impermeable seal wherein said closure is configured to inhibit air from entering and escaping said bag, said closure comprising:
a first mating member being coupled to said inside surface corresponding to said first side of said bag, said first mating member being coextensive with said top edge,
a second mating member being coupled to said inside surface corresponding to said second side of said bag, said second mating member being coextensive with said top edge, said second mating member selectively engaging said first mating member to selectively close said bag, said second mating member forming a fluid impermeable seal with said first member, and
a slide being slidably coupled to said bag wherein said slide is configured to be manipulated, said slide being positioned on said top edge, said slide being in mechanical communication with each of said first and second mating members, said slide selectively opening and closing said bag.
